(19) United States
(12) Patent Application Publication
(10) Pub. No.: US 2006/0108502 A1
(43) Pub. Date: May 25, 2006

(54) Microscope light regulator

(76) Inventors: Bernard Petrillo, Rye, NY (US); Bruno Israel, Kinderhook, NY (US)

Correspondence Address: RHODES INSTRUMENT CORPORATION, 11 VIRGINIA ROAD, N. WHITE PLAINS, NY, 10603, US

(21) Appl. No.: 11/323,924

(22) Filed: Jan. 3, 2006

Related U.S. Application Data
(63) Continuation-in-part of application No. 10/605,101, filed on Sep. 9, 2003.

(51) Int. Cl. G01J 1/32

(52) U.S. Cl. 250/205

(57) ABSTRACT

A control system has been designed that maintains the overall intensity of a microscope's viewed image at a constant level. The system is further enhanced to match the color character of the microscope illuminator to a user-established color reference for replication and comparison purposes. A comparison bridge utilizing this system is described that is fully balanced in intensity and color character.

### BACKGROUND OF THE INVENTION

1. Field of the Invention

The invention relates to the need to provide a method that can achieve a constant level of illumination of the viewed image when performing analyses with a microscope. This invention can also result in the illumination characteristics at the point of viewing being dynamically intensity and color balanced with regard to a chosen reference.

2. Description of the Prior Art

Typical microscope systems employ various methods of intensity and spectral control of the illuminator. While the output intensity of the illumination source has been regulated, it does not consider any attenuation or unwanted spectral-changing effects that occur in the optical path between the illumination output and the viewed image. Various sections of a microscope's optical system have been stabilized and corrected, but no single system has provided stabilization of a viewed image by actively altering the intensity and color structure of the illuminating source.

Applications exist that are enhanced when the illumination is sampled and regulated at the point where the image is being viewed. These are (1) when the operator is optimizing viewing adjustments or when repositioning the specimen results in wide attenuation swings, (2) when real-time comparative studies are performed, and (3) when it is necessary to accurately recreate the illumination conditions associated with a former viewed image.

Normal use of a microscope requires constant changing of lenses, filters, and diaphragms to optimize the particular objectives. Varying degrees of attenuation are correspondingly introduced into the illumination optical network. To compensate for these alterations in viewing intensity, the user is required to continually readjust the level of the system's illuminator. Associated with these intensity changes in incandescent illuminators are unwanted color temperature shifts in the illumination spectra.

Microscope systems that are used to study the comparative characteristics of two specimens utilize a comparison bridge to view these images. They are essentially two independent optical systems whose final images are presented to the viewer for comparative purposes.

As the output of the illumination of each channel travels its optical path through an array of lenses, filters, and diaphragms, slight differences in the illumination intensity levels between the two channels are experienced. When it is necessary to replicate an illuminated scene that is an exact reproduction of a given value for these analyses, a stored or real-time value of that illumination spectrum must be matched. It is imperative that these two views be intensity and color-balanced to allow an accurate comparison to be performed.

To minimize these imbalances, a single illuminator with a split output for each channel may be implemented. It remains, however, a formidable task to subsequently balance the two optical channels to insure that specimen data introduced in one channel will be identical in intensity and color with the other channel when they are compared.

There are a series of patents and patent applications that approach some of the aforementioned operational problems. However, they have varying degrees of negative attributes when compared to the approaches herein described.

Patent Publication No. 20020191177 A1 describes a computer-assisted system for correcting the image as presented to a camera/monitor viewer. Patent Publication No. 20030184857 follows up this patent submission and modifies the digital data to compensate for unwanted spectral changes. Neither system corrects the image as seen by the operator and they mutually require software, a computer, and monitor to digitally correct the monitor image alone for changes in the illuminator output.

U.S. Pat. No. 4,714,823 does correct the viewed image for intensity variations of the illuminator but does not compensate for color changes in the illuminator/optical system. The corrections are achieved by varying the excitation to the illuminator, which can create undesired color shifts. This approach is not applicable to arc-type illuminators.

U.S. Pat. No. 5,559,631 depicts a color-corrected illuminator that can maintain a constant color temperature but it requires the use of two interwoven illuminators. The prime illuminator is mixed with the output of a secondary illuminator. A complex program alters the color characteristics of the secondary illuminator such that the combined output has the desired color profile. This system is likewise not applicable to arc-type illuminators.

### SUMMARY OF INVENTION

It is an object of this invention to provide a microscope system whose viewed image is maintained at both a constant level of intensity and of spectral quality. These goals are achieved by monitoring the illuminator(s) output and specimen images at the end of their optical travel where the final image is formed for viewing.

It is another object of this invention to establish a comparison bridge for microscopes that compensates for any differences in the relative intensity and spectral quality of the dual optical channels.

Utilizing an array of spectrally matched pairs of detector/LED combinations attains color compensation. A discrete primary color is represented by each of three detector/LED combinations. Each detector senses the color level of a reference image (or stored value) and develops a difference error signal to drive its respective LED until the difference is eliminated. The LED outputs are thereby either added or subtracted to the basic illuminator output to eliminate any relative spectral deviations. Current approaches only use passive filters, which are have appreciable losses and can only decrease the intensity level of a particular color component.

Intensity compensation is attained by using a small sample of the final image to provide error signals for a closed loop servo system that alters the attenuation level of an electronically controlled variable neutral density filter. This active control technique permits either an increase or a decrease in the overall intensity level.

The requisite control circuits can be located internally for new designs or externally for retrofit applications.

### DETAILED DESCRIPTION

Three applications are presented to demonstrate the implementation of this intensity and spectral control concept. In these examples, LEDs (Light Emitting Diodes) are used to generate discrete color components of the visible spectrum. Other light sources could be employed to accomplish similar results.

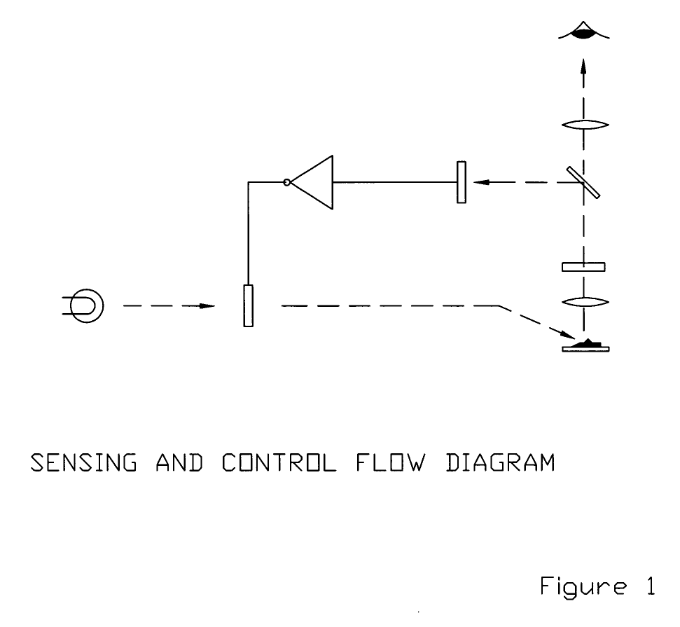

Application No. 1 (FIG. 1)

This is the most basic application. A beam splitter extracts a 2% sample of the overall viewed image and uses this data to maintain this scene constant.

FIG. 1 depicts the conventional optical path traversed by the combined illuminator energy and the image of the specimen 1 in a typical microscope system. (The prime optical components of the microscope that can alter the intensity and character of the viewed image are the objective lens 7, various filters 8, the sampling beam splitter 4, and the eyepiece lens 9.) In addition, a feedback loop has been added that controls the attenuation of the variable density filter 3. The input for the feedback loop is optical data sampled via the beam splitter 4 and fed to a photodetector 10. This beam splitter 4 is a thin optical cover glass that only removes about 2% of the total light energy.

Operationally, the operator sets the illuminator 5 at its rated value and manually adjusts the electronically controlled variable neutral density filter 3 while the feedback loop is disabled. Once the desired intensity level for viewing the specimen is attained, the setting is stored in the feedback circuit 2 and the loop is activated. The beam splitter data sample is subsequently continuously compared to the stored data. Any deviation in the light sample generates a difference error signal that is nulled by automatically altering the attenuation of the variable neutral density filter 3.

The characteristics of the variable filter should be equivalent to the Anteryon Model LCP-250. This filter has a flat frequency response throughout the visible spectrum, millisecond response times, and an 80% attenuation range. In addition, it does not need additional polarizing filters with their typical 30% losses.

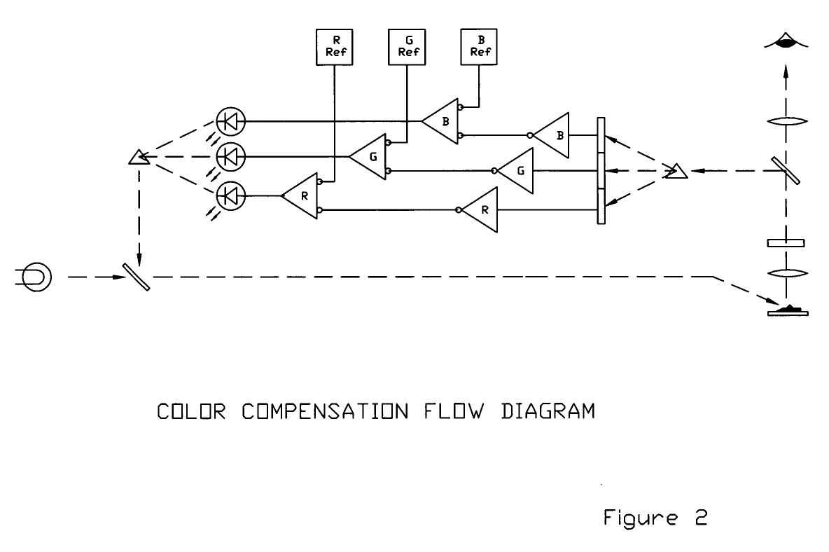

Application No. 2 (FIG. 2)

The same closed loop approach is utilized to maintain the spectral characteristic of the illuminator constant at the point of viewing. In this application, any specimen(s) are initially removed from the microscope stage so that the output beam splitter only samples the illuminator output. This sample illuminates a prism (or a diffraction grating) 11 that spatially spreads its color components.

These components are sensed by three angularly displaced detectors 12a, 12b, and 12c. The relative displacement of these detectors serves to selectively sense three unique colors of the illumination spectrum (e.g., red, blue, and green).

The amplified outputs of the detectors are compared in comparators 13a, 13b, 13c to stored references 14a, 14b, 14c to develop three independent differential error signals that control the output levels of the LEDs 15a, 15b, 15c. Each LED is color-matched to it's respective detector. The outputs of these LEDs are gathered by a prism 16 and directed at a beam splitter 17 where they are mixed with the illuminator output.

The LEDs are driven to eliminate the detected error signals thereby matching the stored reference parameters. This feedback loop maintains the composite illuminator/LED output at the historically derived and stored values.

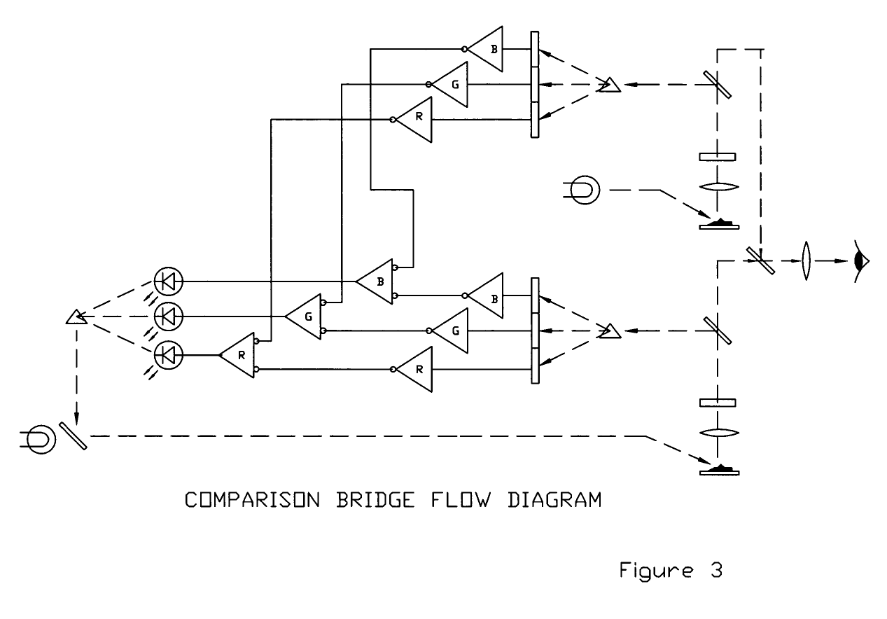

Application No. 3 (FIG. 3)

The system of Application No. 2 is extended to match the intensity and color characteristics of the dual optical channels of a comparison bridge. The stored data in Application No. 2 is replaced with a dynamic sample of the reference channel's illumination characteristics.

This application requires that two viewing systems have identical optical characteristics. Two specimens are examined to determine if, in fact, they are identical. The original (or reference) optical system is activated and a reference specimen 1 a is viewed. A second specimen 18 is imaged in the comparison channel and presented to the viewer in a composite display for identity analysis. In place of the stored color reference, a prism (or diffraction grating) 19 is utilized to extract the reference color levels of the comparison channel's illuminator 20. A second prism (or diffraction grating) 11 provides a similar set of color levels from the comparison optical channel. These levels are compared to the primary channel values and the differences are nulled out by driving the output LED array. The LED outputs are combined in a prism 16 and merged with the illuminator output in beam splitter 17. The combined output is driven until it matches the reference channel data.

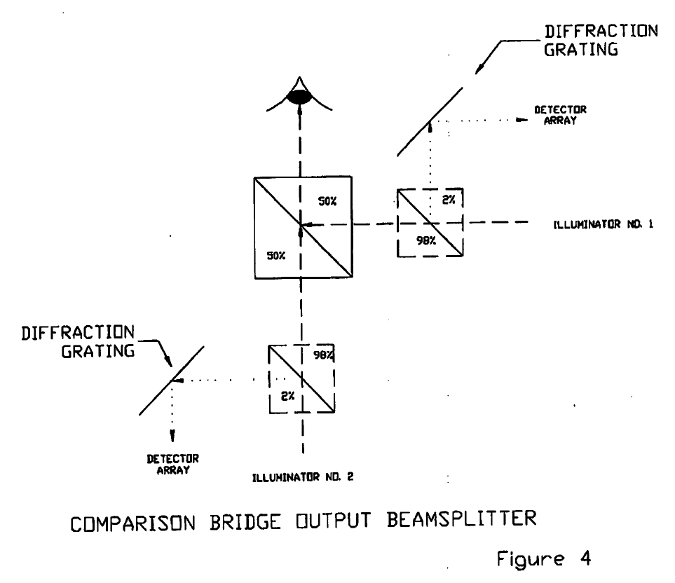

The optical data of the two channels are merged by the 50/50 beam splitter 21 for comparative viewing. FIG. 4 details the optical paths of the two images as they traverse the beam splitter output network. The resulting contribution of each composite illuminator to their respective final viewed images will be identical.

What is claimed is:

1. A control system for microscopes that regulates the intensity and spectral characteristics of the viewed image at a constant level wherein the system uses a small beam splitter-derived sample of the viewed image as a reference to provide closed loop compensation for any image variations in the total optical paths of the microscope.

2. The control system of claim 1, further comprising: an array of color-radiating devices whose outputs are merged with an illuminator's output to maintain the combined spectra of the illuminator constant.

3. The control system of claim 2, further comprising: the capability of equalizing the dual paths of a comparison bridge to eliminate any differences in color quality of the respective illuminators at the final point of comparison viewing.

4. A microscope illuminator having a spectral output that can be modified by the controlled addition of discrete active color radiator outputs.
